(19) United States
(12) Patent Application Publication
(10) Pub. No.: US 2022/0142408 A1
(43) Pub. Date: May 12, 2022

(54) Foldable Used Charcoal and Ashes Storage Bag

(71) Applicants: Donald Merriweather, Flossmoor, IL (US); Craig Ford, JR., Chicago, IL (US)

(72) Inventors: Donald Merriweather, Flossmoor, IL (US); Craig Ford, JR., Chicago, IL (US)

(21) Appl. No.: 17/519,674

(22) Filed: Nov. 5, 2021

Related U.S. Application Data
(60) Provisional application No. 63/112,338, filed on Nov. 11, 2020.

(51) Int. Cl. A47J 37/07; F24B 13/00

(52) U.S. Cl. CPC A47J 37/0786; F24B 13/006

(57) ABSTRACT

The present invention relates to a foldable containment bag for charcoal, designed to seamlessly remove used or spent charcoal and ashes directly from a grill. The bag can be unfolded in a planar sheet to insert into a grill. The sheet is flexible and conforms to the shape of the inside surface of the grill. The sheet includes a top surface, a bottom surface and a mesh of flexible aluminum wiring disposed within the top surface and the bottom surface. During use, charcoal is placed on the top surface of the sheet, and after use of the grill, the sheet can be folded to form a bag that firmly secures the used charcoal and associated ashes for transportation and disposal. The bag can have folding lines to fold and unfold for use.

### CROSS-REFERENCE TO RELATED APPLICATION

The present application claims priority to, and the benefit of, U.S. Provisional Application No. 63/112,338, which was filed on Nov. 11, 2020 and is incorporated herein by reference in its entirety.

### FIELD OF THE INVENTION

The present invention relates generally to the field of containers and similar devices. More specifically, the present invention relates to a charcoal containment bag made up aluminum sheet having embedded wiring structure and handles to maintain strength and stability of the bag. The charcoal containment bag is configured to be used for removing used charcoal and ashes directly from the grill. With the charcoal containment bag, the users can place charcoal directly on the bag and insert into the grill and cook food with ease. Once the charcoal is utilized, the spent charcoal and its ashes inside the bag can be wrapped up and thrown away in a mess-free manner. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, use of grills and barbeques is quite common among food lovers. Generally, gas grills and charcoal grills are known in the state of the art for cooking grilled food. However, due to the mechanisms and complexity, gas grills are more expensive than charcoal grills. Also, with the charcoal grills, the grilled food gets a smoky sear that cannot be achieved by any gas grills. Therefore, charcoal grills are mostly preferred by flavor buffs for cooking grilled food.

In charcoal grills, an appropriate amount of charcoal is filled or piled inside the base or bottom section of a grill. A piece of newspaper or other fire starter can be ignited and placed into the bottom section of the grill in order to light the charcoal edges. After the charcoal has burned for a period of time and attains an adequate temperature required for cooking food, the desired uncooked food can be placed on a grate positioned over the charcoal for cooking. Once the food is cooked, the charcoal and its ashes are left to cool for subsequent removal. After the ashes are removed, the grill can be packed or set aside for future use. The ashes can create a mess in and around the grill that can be difficult to clean. Removing used charcoal from a grill can be an incredibly frustrating and messy process. Individuals may need to dust themselves off and even change clothes after dumping spent charcoal ashes. Some individuals may also be forced to take a shower, do laundry, etc. after dumping charcoal. Although individuals may love the food grilled using charcoal grills, the ash-cleaning process can be annoying. Due to the messy process of cleaning charcoal ashes, individuals may be less interested in using charcoal grills.

Therefore, there exists a long felt need in the art for a device that enables the users to easily dispose of used charcoal from the charcoal grills. There is also a long felt need in the art for a device that allows the users to clear the charcoal ashes easily while packing up the grill set. Additionally, there is a long felt need in the art for a device that prevents the users from getting dirty due to the mess created by used charcoal and its ashes in a grill setup. Moreover, there is a long felt need in the art for a device that prevents the charcoal from creating a mess in and around the grills while cooking food. Further, there is a long felt need in the art for a device that provides a mess-free solution for dumping used charcoal and associated ashes. Furthermore, there is a long felt need in the art for a device that allows the users to easily dispose of charcoal/ashes without getting their clothes dirty, thereby eliminating the need to change clothes after cleaning a charcoal grill once the food is cooked. Finally, there is a long felt need in the art for a device that enables the users to quickly clean up charcoal/ashes, and eliminates all cleanup time required for charcoal grills.

The subject matter disclosed and claimed herein, in one embodiment thereof, comprises a foldable containment bag for charcoal. The foldable containment bag seamlessly removes used charcoal and ashes directly from the grill without any mess. The foldable containment bag includes: a generally rectilinear flexible aluminum sheet having four edges; the sheet having a top surface, a bottom surface and a flexible mesh of aluminum wiring disposed between the top surface and the bottom surface; a handle disposed proximal to each edge; the aluminum sheet is configured to be inserted into a grill wherein charcoal to be used for grilling is then placed on the top surface; and the aluminum sheet, after grilling, is folded into a bag securing the charcoal and associated ashes for easy transportation. The sheet can be folded to form a bag which can then be easily carried while firmly securing the used charcoal and ashes.

In this manner, the novel charcoal containment bag of the present invention accomplishes all of the forgoing objectives, and provides a relatively safe, easy, and convenient solution to dispose used charcoal and ashes from a grill in a mess-free manner. The charcoal containment bag of the present invention is also user-friendly, as it does not take much effort and time of the user to clean the mess created by charcoal used in charcoal grills. With the charcoal containment bag, the clothes of the users do not get dirty while cleaning and dumping used charcoal from the grills, thereby obviating the steps of extensive hand washing and clothes cleaning after removing ashes from the grill. Additionally, the charcoal containment bag eliminates the cleaning time for used charcoal/ashes, and ensures that individuals remain interested in using charcoal grills.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a foldable containment bag for disposing of used charcoal and ashes. The foldable containment bag is designed for seamless removal of used charcoal and ashes directly from the grill. The foldable containment bag further comprises: a generally rectilinear flexible aluminum sheet having four edges; the sheet including a top surface, a bottom surface, and a flexible mesh of aluminum wiring disposed between the top surface and the bottom surface; a handle disposed proximal to each edge; the aluminum sheet is configured for placement into a grill wherein charcoal for use in grilling is placed on the top surface; and, the aluminum sheet can be folded into a bag, securing the charcoal and associated ashes for easy transportation.

In yet another embodiment of the present invention, the foldable containment bag for charcoal is inserted into the grill in an unfolded or flat position, wherein the bag is in the form of a rectilinear and planar sheet that conforms to the shape of the grill after insertion. After use of the grill, the sheet can be folded into a bag shape that firmly secures the charcoal and ashes therein for easy transportation and disposal.

In a further embodiment of the present invention, a method for removing used charcoal and ashes directly from a grill is described. The method includes: holding a planar, flexible and generally rectilinear aluminum sheet; inserting same into the bottom of the grill; placing charcoal thereon on the top surface of the sheet spaced from the edges and handles of the aluminum sheet, wherein the handles are positioned proximal to the edges about an outer perimeter of the sheet; and, folding the sheet along folding lines disposed within the aluminum sheet, wherein the folding forms walls and flaps to secure the spent charcoal and associated ashes previously placed on the top surface. An embedded mesh of flexible aluminum wiring stabilizes and secures the charcoal for transportation.

In a further embodiment of the present invention, the aluminum sheet can include at least one set of folding lines, thereby enabling a portion of the sheet to form walls and a portion of the sheet to form flaps to firmly secure the charcoal and associated ashes.

In a further embodiment of the present invention, a method for using a foldable bag for removing used charcoal and ashes directly from a grill is described. The method includes: unfolding a charcoal containment bag to form a flat and planar flexible aluminum sheet; inserting the sheet into a grill wherein the sheet conforms to a bottom surface of the grill; the sheet includes a top surface, a bottom surface and an embedded mesh of flexible aluminum wiring disposed within the top surface and the bottom surface; placing charcoal on the top surface of the sheet; enabling the charcoal to cool down after use of the grill; folding the sheet into a bag by folding edges of the sheet using handles disposed within the sheet; and transporting the bag firmly securing the used charcoal and ashes for disposal.

In yet a further embodiment of the present invention, the containment bag allows users to place charcoal directly on a top surface of the bag in an unfolded position after the bag is inserted into the grill. The bag is able to hold, retain, or corral the charcoal during the flaming, burning, heating and cooking cycles, and enables users to wrap up the charcoal and all associated ashes within the bag after using the grill for mess-free disposal. The containment bag can be unfolded to insert into a grill, and subsequently re-folded to carry used charcoal and ashes away from the grill for disposal. The folding and unfolding can be done along the folding edges or along any edge of the bag as per the preference of the users.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a foldable charcoal and ashes storage bag of the present invention in an unfolded state in accordance with the disclosed architecture;

FIG. 2 illustrates a perspective view of one potential embodiment of the foldable charcoal and ashes storage bag of the present invention in a folded state in accordance with the disclosed architecture;

FIG. 3 illustrates a perspective view of one potential embodiment showing the foldable charcoal and ashes storage bag of the present invention inserted into a grill in an unfolded state in accordance with the disclosed architecture;

FIG. 4 illustrates a perspective view of one potential embodiment showing charcoal placed on unfolded rectilinear aluminum sheet in accordance with the disclosed architecture;

FIG. 5 illustrates a perspective view of one potential embodiment showing how consumed or used charcoal is removed from the grill while still within the aluminum sheet in accordance with the disclosed architecture; and

FIG. 6 illustrates a perspective view of another potential embodiment of a foldable charcoal and ashes storage bag of the present invention in an unfolded state in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that enables the users to easily dispose of used charcoal from the charcoal grills. There is also a long felt need in the art for a device that allows the users to clear the charcoal ashes easily while packing up the grill set. Additionally, there is a long felt need in the art for a device that prevents the users from getting dirty due to the mess created by used charcoal and its ashes in a grill setup. Moreover, there is a long felt need in the art for a device that prevents the charcoal from creating a mess in and around the grills while cooking food. Further, there is a long felt need in the art for a device that provides a mess-free solution for dumping used charcoal and associated ashes. Furthermore, there is a long felt need in the art for a device that allows the users to easily dispose charcoal/ashes without getting their clothes dirty, thereby eliminating the need to change clothes after cleaning a charcoal grill once the food is cooked. Finally, there is a long felt need in the art for a device that enables the users to quickly clean up charcoal/ashes and eliminates all cleanup time required for charcoal grills.

The present invention, in one exemplary embodiment, is a novel method for removing used charcoal and ashes directly from a grill is described. The method includes: holding a planar, flexible and generally rectilinear aluminum sheet; inserting same into the bottom of the grill; placing charcoal thereon on the top surface of the sheet spaced from the edges and handles of the aluminum sheet, wherein the handles are positioned proximal to the edges of the sheet; and, folding the sheet along folding lines disposed within the aluminum sheet, wherein the folding forms walls and flaps to secure the spent charcoal and associated ashes previously placed on the top surface. An embedded mesh of flexible aluminum wiring stabilizes and secures the charcoal for transportation.

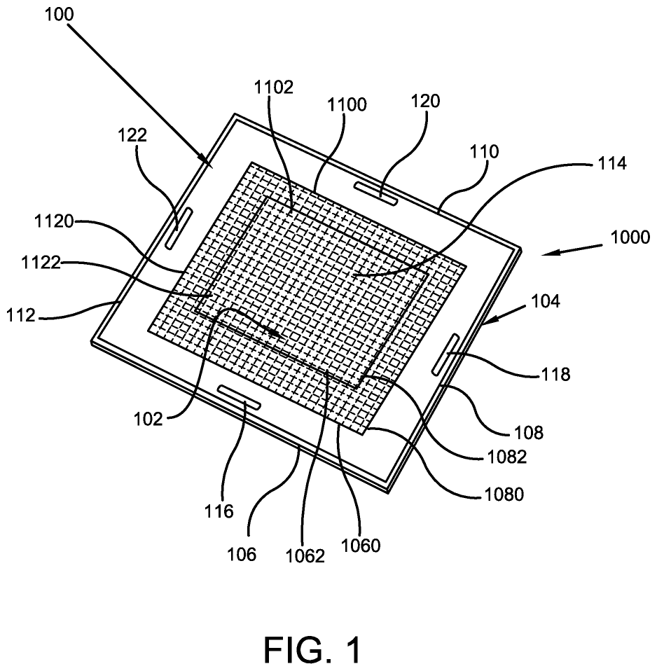

Referring initially to the drawings, FIG. 1 illustrates a perspective view of one potential embodiment of a foldable charcoal and ashes storage bag or liner of the present invention in an unfolded state in accordance with the disclosed architecture. The foldable charcoal and ashes storage bag or liner 100 of the present invention is designed to be inserted into a grill in the unfolded position, for placing at the bottom of a charcoal grill. Thereafter, charcoal is piled onto a top surface of the bag 100. Thus, the bag or liner 100 is positioned between the charcoal and a bottom surface of a grill base. After use, the charcoal, that was used in the grilling process, can be seamlessly and completely removed after use, along with the associated ashes directly from the grill. More specifically, the bag 100 includes a rectilinear aluminum sheet 1000 having a top surface or layer 102 and a bottom surface or layer 104. Both the top surface 102 and the bottom surface 104 can be made of aluminum, and include an embedded mesh 114 of thin aluminum wire between the top surface 102 and the bottom surface 104.

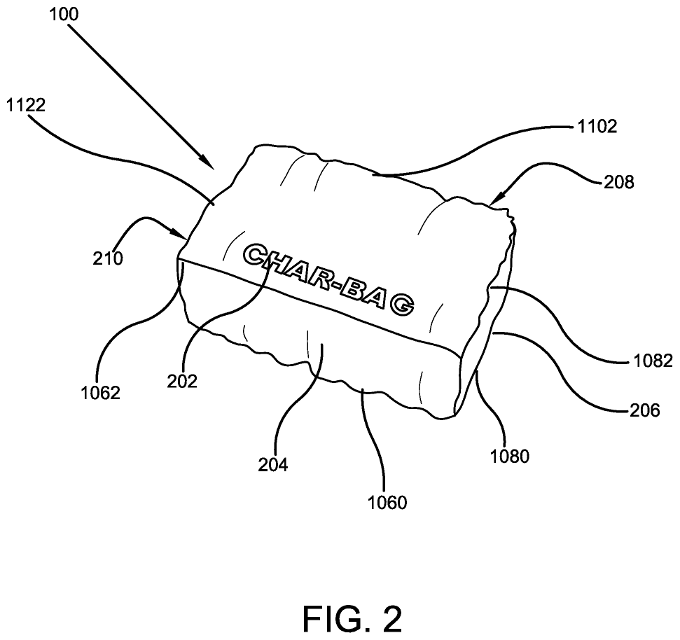

In one potential embodiment, the rectilinear sheet 1000 can be formed into a cuboidal box to easily carry and store the used charcoal as illustrated best in FIG. 2. The rectilinear sheet 1000 can include four edges 106, 108, 110, 112 along with a handle disposed near the center of each edge for folding and unfolding the bag 100. As shown, a first handle 116 is disposed near the center of the first edge 106, a second handle 118 is disposed near the center of the second edge 108, a third handle 120 is disposed near the center of the third edge 110 and a fourth handle 122 is disposed near the center of the fourth edge 112. Each handle 116, 118, 120, 122 can be in the form of small cut-out that can be held by a user to fold and unfold the charcoal bag 100.

For folding and unfolding, and for providing the charcoal bag 100 in a stable position when holding the used or spent charcoal, the aluminum sheet 1000 includes two folding lines parallel to each edge. The folding lines enable the aluminum sheet 1000, including the embedded aluminum mesh 114, to fold along the edges for forming the bag as illustrated in FIG. 2, and unfold to insert into a grill. The first set of folding lines include a first outer folding edge 1060 parallel to the first edge 106, a second outer folding line 1080 parallel to the second edge 108, a third outer folding line 1100 parallel to the third edge 110 and a fourth outer folding line 1120 parallel to the fourth edge 112. Each outer folding line is equidistant from a corresponding edge. A second set of folding lines include a first inner folding edge 1062 parallel to the first edge 106, a second inner folding line 1082 parallel to the second edge 108, a third inner folding line 1102 parallel to the third edge 110 and a fourth inner folding line 1122 parallel to the fourth edge 112. Each inner folding line is equidistant from the corresponding edge and corresponding outer folding line.

In operation, to fold the sheet 1000 to a bag shape (as shown in FIG. 2), the sheet 1000 is initially folded along the inner folding lines 1062, 1082, 1102, 1122 to form four walls extending vertically with a height equal to the distance between each inner folding line and the corresponding edge. The walls create an opening, and to cover the opening created between the walls, the sheet 1000 is again folded along the outer folding lines 1060, 1080, 1100, 1120 towards each other, such that the opening is completely covered to easily carry the stored charcoal and ashes.

For unfolding the bag 100, the sheet 1000 is unfolded initially along the outer folding lines 1060, 1080, 1100, 1120, and then along the inner folding lines 1062, 1082, 1102, 1122, to form the flat rectilinear-shaped unfolded sheet 1000 to insert into the grill for placing charcoal for cooking purposes.

FIG. 2 illustrates a perspective view of a foldable charcoal and ashes storage bag of the present invention in a folded state in accordance with the disclosed architecture. As shown, in a folded state, the bag 100 comprises a containment bag for charcoal for easy carriage and disposing off with ease. The embedded wiring of the bag 100 between the top layer and bottom layer as defined in FIG. 1, enables stability and strength when storing and transporting charcoal. The bag 100 can have an indicia 202 such as a “Charbag” logo for branding and advertising purposes. The indicia 202 is positioned such that it remains visible along the top of the bag 100.

In a folded state, the stored charcoal is protected by the walls 204, 206, 208, 210, formed by the inner folding lines 1062, 1082, 1102, 1122, as best shown in FIG. 1. The stored charcoal is further secured by flaps formed by folding the sheet along outer folding lines 1060, 1080, 1100, 1120, as best shown in FIG. 1, to fold completely into the folded bag 100.

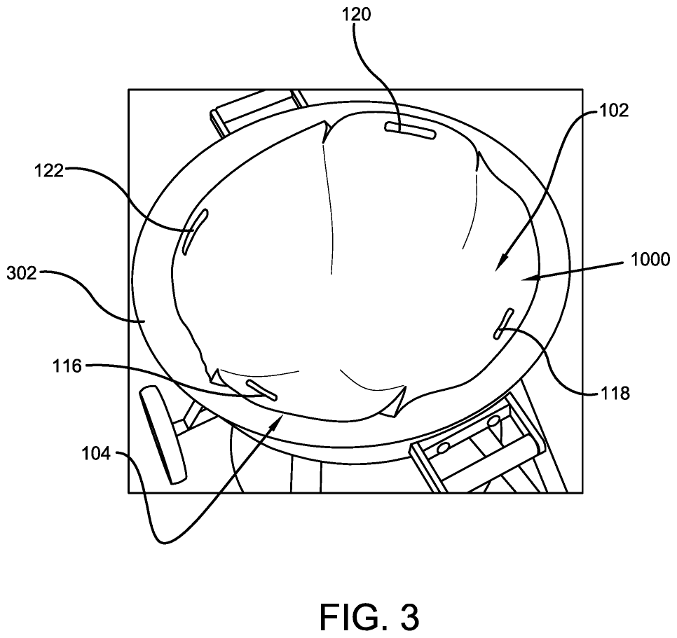

FIG. 3 illustrates a perspective view showing the foldable charcoal and ashes storage bag of the present invention inserted into a grill in an unfolded state in accordance with the disclosed architecture. The bag 100 can be used in an unfolded state for placing or inserting into a grill 302. The embedded aluminum wiring is flexible, thereby enabling the unfolded sheet 1000 to conform to any shape of the grill 302. The bag 100 can be unfolded along the outer folding lines and inner folding lines, and conforms to the shape of the grill 302. During use, the top surface 102 is used for placing the charcoal thereon. The bottom surface 104 faces towards the inside surface of the grill 302. The handles 116, 118, 120, 122, positioned proximal to an outer perimeter of the sheet 1000, can be used for folding and unfolding the sheet 1000, thereby enabling the user to easily place charcoal on the top surface 102 and fold, for holding and transporting the used charcoal and ashes. The handles enable the user to simply wrap up the charcoal and all ashes within the sheet 1000 after using the grill for a mess-free disposal.

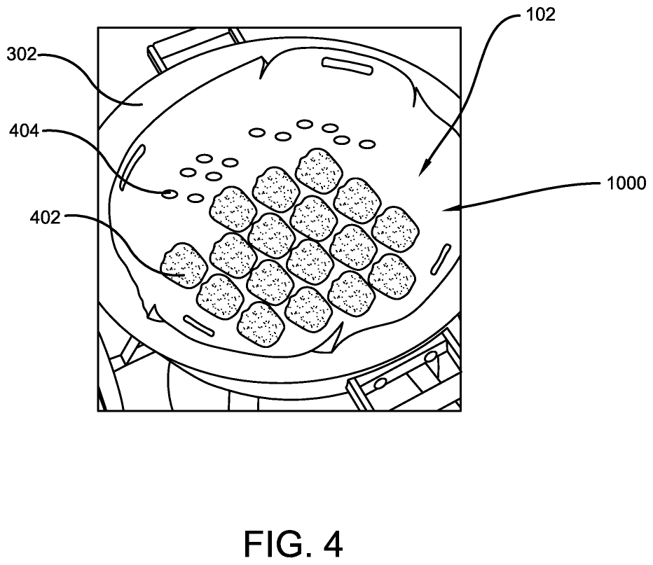

FIG. 4 illustrates a perspective view showing charcoal placed on an unfolded rectilinear aluminum sheet in accordance with the disclosed architecture. The top surface 102 of the sheet 1000 is configured to accommodate charcoal 402. The charcoal 402 during use in the grill 302 is burnt or consumed, wherein the resulting ashes 404 remain on the top surface 102. After use of the grill 302, the sheet 1000 can be folded using the handles (as described in FIGS. 1 and 3) to wrap the charcoal 402 and the ashes 404 for easy transportation in a convenient manner. Thereafter, the charcoal 402 and the ashes 404 can be dumped easily, obviating the cleanup time required for charcoal grills and cleanup of the person removing spent charcoal and ashes. Preferably, once the charcoal 402 and the ashes 404 have cooled, the sheet 1000 can be folded up in the form of a bag with the charcoal and ashes for disposal. The entirety of the spent charcoal 402 and ashes 404 can be securely placed inside the folded bag.

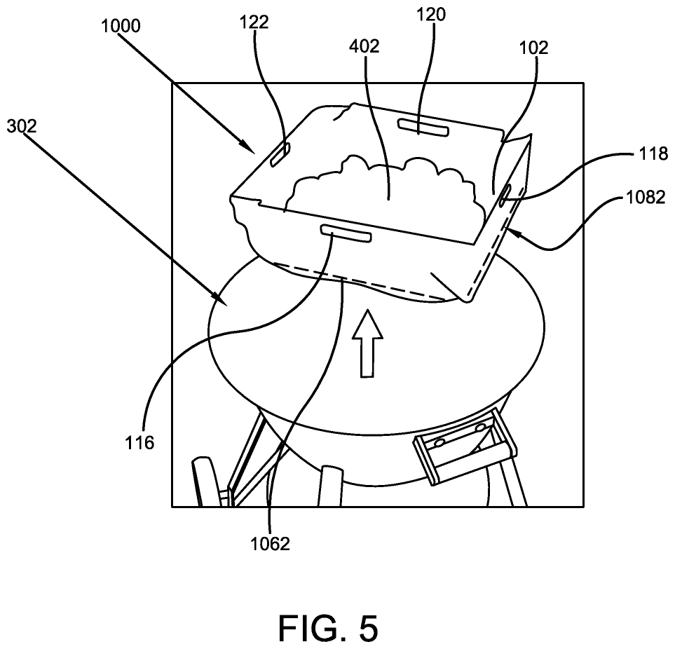

FIG. 5 illustrates a perspective view showing how used or spent charcoal 402 is removed from the grill 302 while still within the aluminum sheet 1000, in accordance with the disclosed architecture. After use of the grill 302, the aluminum sheet 1000 can be folded with the charcoal 402 placed on the top surface 102. The aluminum sheet 1000 can be folded using the handles 116, 118, 120, 122, and the sheet 1000 can be folded along the inner folding lines 1062, 1082 and (1102, 1122; shown in FIG. 1). It should be noted that the sheet 1000 can be folded into the folded bag condition along any edge as the aluminum mesh is flexible while providing adequate strength. When the charcoal 402 is cooled, the sheet 1000 can be folded up with the charcoal and ashes firmly secured within the bag for easy disposal.

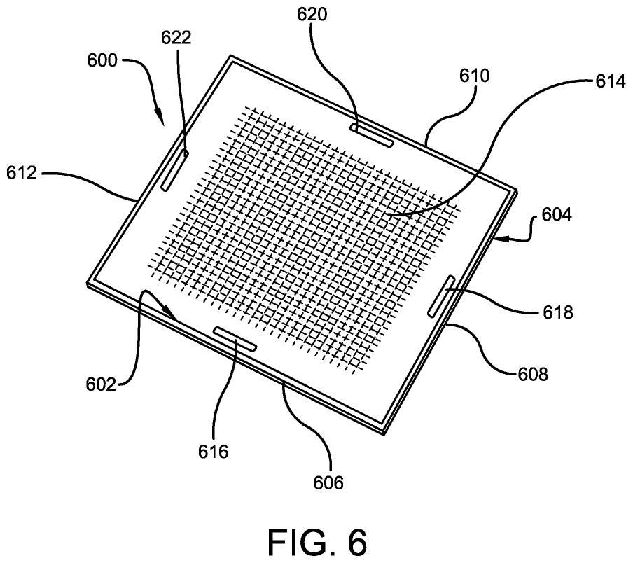

FIG. 6 illustrates a perspective view of another potential embodiment of the foldable charcoal and ashes storage bag of the present invention in an unfolded state, in accordance with the disclosed architecture. In the present embodiment, the foldable bag 600 does not contain any folding edges and can be folded in any shape, using the edges 606, 608, 610, 612 and handles 616, 618, 620, 622. Depending on the volume of the charcoal placed on top surface 602, the flexible aluminum mesh 614 supports the charcoal for easy transportation. When placed on a grill, the bottom surface 604 lies on, or lines, the inside surface of the grill whereby the charcoal is placed on the top surface 602. It should be appreciated that the bag 600 can be a rectilinear aluminum sheet, or circular sheet, in the unfolded state, and can take any shape when folded, thereby securing the charcoal and ashes depending on the volume of the charcoal. The foldable charcoal and ashes storage bags 100, 600 can also be used for fireplace ashes, and is environmentally friendly.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “foldable charcoal and ashes storage bag”, “charcoal containment bag”, “charcoal and ashes storage bag”, “charcoal bag” and “bag”, are interchangeable and refer to the foldable charcoal and ashes storage bag 100, 600 of the present invention.

Notwithstanding the forgoing, the foldable charcoal and ashes storage bag 100, 600 of the present invention can be of any suitable size and configuration as is known in the art without affecting the overall concept of the invention, provided that it accomplishes the above-stated objectives. One of ordinary skill in the art will appreciate that the size, configuration and material of the foldable charcoal and ashes storage bag 100, 600 as shown in the FIGS. are for illustrative purposes only, and that many other sizes and shapes of the foldable charcoal and ashes storage bag 100, 600 are well within the scope of the present disclosure. Although the dimensions of the foldable charcoal and ashes storage bag 100, 600 are important design parameters for user convenience, the foldable charcoal and ashes storage bag 100, 600 may be of any size that ensures optimal performance during use, and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A charcoal grill liner for containing a spent charcoal, the charcoal grill liner comprising:
a flexible sheet comprising a top layer and a bottom layer, wherein said flexible sheet is planar prior to installation; and
a mesh disposed between said top layer and said bottom layer, wherein the flexible sheet comprises a plurality of handles for holding said flexible sheet and the spent charcoal.

2. The charcoal grill liner of claim 1, wherein said flexible sheet is rectilinear.

3. The charcoal grill liner of claim 1, wherein said flexible sheet is foldable along a plurality of fold lines for containing the spent charcoal.

4. The charcoal grill liner of claim 1, wherein said flexible sheet is disposable.

5. The charcoal grill liner of claim 1, wherein said flexible sheet is circular.

6. The charcoal grill liner of claim 1, wherein said mesh comprises a thin aluminum wire.

7. A charcoal grill liner for containing a spent charcoal, the charcoal grill liner comprising:
an aluminum sheet comprising a top layer and a bottom layer;
a mesh disposed between said top layer and said bottom layer; and
a plurality of handles for holding said aluminum sheet and the spent charcoal.

8. The charcoal grill liner of claim 7, wherein said aluminum sheet is flexible.

9. The charcoal grill liner of claim 8, wherein said aluminum sheet is planar prior to installation.

10. The charcoal grill liner of claim 9, wherein said aluminum sheet is rectilinear.

11. The charcoal grill liner of claim 10, wherein said aluminum sheet is foldable along a plurality of fold lines for containing the spent charcoal.

12. The charcoal grill liner of claim 11, wherein said aluminum sheet is disposable.

13. The charcoal grill liner of claim 7, wherein said aluminum sheet is rectilinear.

14. The charcoal grill liner of claim 7, wherein said aluminum sheet is circular.

15. The charcoal grill liner of claim 7, wherein said mesh comprises a thin aluminum wire.

16. The charcoal grill liner of claim 7, wherein said plurality of handles are spaced around an outer perimeter of said aluminum sheet.

17. A method of removing and containing a spent charcoal from a grill, the method comprising the steps of:
lining an inside surface of the grill with an aluminum sheet, wherein said aluminum sheet comprises a top layer, a bottom layer, a mesh disposed between said top layer and said bottom layer, and a plurality of handles;
piling a charcoal onto said aluminum sheet;
burning the charcoal on said aluminum sheet;
grasping said aluminum sheet by at least two handles of said plurality of handles; and
removing said aluminum sheet and the spent charcoal from the grill.

18. The method of claim 17, wherein said sheet is aluminum flexible.

19. The method of claim 17, wherein said aluminum sheet is planar prior to lining said inside surface of the grill.

20. The method of claim 17 further comprising a step of folding said aluminum sheet along a plurality of fold lines.
